(19) United States
(12) Patent Application Publication
(10) Pub. No.: US 2002/0111409 A1
(43) Pub. Date: Aug. 15, 2002

(54) Polyester compositions having improved color stability

(76) Inventor: Sapna H. Talibuddin, Vernon, IN (US)

Correspondence Address: CANTOR COLBURN, LLP, 55 GRIFFIN ROAD SOUTH, BLOOMFIELD, CT, 06002

(21) Appl. No.: 09/683,585

(22) Filed: Jan. 22, 2002

Related U.S. Application Data
(60) Provisional application No. 60/136,592, filed on May 28, 1999.

(51) Int. Cl. C08K 3/32; C08K 3/22; C08K 3/18

(52) U.S. Cl. 524/417; 524/430; 524/420

(57) ABSTRACT

Polyester resin compositions, including flame retardant compositions, having improved color stability are prepared containing a mixture of polyester resin, e.g., polybutylene terephthalate, a polycarbonate polymer, e.g., a brominated polycarbonate, a quencher concentrate comprising a mixture of a polyester resin and a Group I or II metal phosphate, an antimony compound as a synergist and/or a light-colored pigment, e.g., zinc sulfide. Addition of the quencher compound in the form of resin concentrate rather than in neat form reduces the development of reactions between the quencher and synergist/pigment combination which can cause discoloration of the composition when thermoprocessed.

### CROSS REFERENCE TO RELATED APPLICATIONS

This application claims the benefit of U.S. application Ser. No. 09/550,146 filed Apr. 17, 2000, which claims the benefit of U.S. Provisional Patent Application Serial No. 60/136,592 filed May 28, 1999 which are hereby incorporated by reference.

### BACKGROUND OF INVENTION

This invention relates to thermoplastic polyester compositions having improved color stability.

Polyester compositions comprising a blend of polyester (PE) and polycarbonate (PC) polymers have been widely used in the automotive, appliance, and electrical industries to form molded parts where impact strength, rigidity, toughness, heat resistance, solvent resistance and good electrical properties are desired. PE resins such as polybutylene terephthalate are semi-crystalline engineering plastics that possess good solvent resistance but less than optimum impact strength. In contrast, aromatic polycarbonate polymers such as bisphenol-A polycarbonate are generally amorphous engineering thermoplastics possessing good impact strength but less than optimum solvent resistance. By blending such materials, a polymer alloy is formed having both good impact strength and good solvent resistance.

Where flame retardant properties are desired in such compositions, it is desirable to include in the formulation one or more organic halogen-containing compounds which enhance the resistance of the composition to burning or ignition, usually in combination with a synergist comprising an antimony oxide auxiliary flame retardant. These halogenated flame retardant compounds generally comprise aromatic bromine compounds such as brominated bis phenols, brominated bis amides, brominated polystyrene and the like. A preferred flame retardant may comprise a low molecular weight halogenated polycarbonate such as a polycarbonate oligomer prepared using brominated bisphenol-A as a raw material. The brominated polycarbonate may constitute all or a portion of the polycarbonate component of the blend. Compositions of this type are disclosed in U.S. Pat. Nos. 4,927,870, 5,194,481 and 5,773,502.

Blends comprising polyester and polycarbonate, however, tend to undergo ester-carbonate interchange when heated, wherein ester linkages in both the polycarbonate and the polyester are believed to be broken and replaced by alkylene carbonate and arylene carboxylate bonds. The result is degradation of the physical properties of the polymers due to hybridization of the molecular linkages therein. Without being held to any particular theory, it is believed that metal catalyst residues from the polymerization reaction forming the polyester promote the ester-carbonate interchange in these compositions. This interchange leads to variability in the properties of articles finally fabricated from the blends.

It is known that the addition of minor quantities of Periodic Table Group I or Group II metal phosphate salts to such blends will deactivate (quench) the catalyst residues thereby greatly reducing ester-carbonate interchange, while at the same time maintaining the hydrolytic stability and melt viscosity of the composition, as disclosed in U.S. Pat. No. 5,354,791.

However, the solution of one problem relating to PE/PC blends has been found to lead to another problem which may arise in certain applications. Many phosphoric acid based quenchers tend to react with the antimony oxide component present in flame retarded blends at polymer processing temperatures, or use temperatures, above 120° C., yielding a dark or brown-colored product. Also, certain light-colored pigments added to the composition to produce white or light-colored products, e.g., zinc sulfide, also may react with the quencher or the quencher/antimony oxide combination to yield discolored products. Thus, whereas the discoloration phenomenon may not be a problem in most applications or where coloration is not of concern, it can be a problem where white or light-colored articles are prepared, e.g., oven handles or trim or other appliance components subject to heat such as toasters, broilers, dryers, hair styling devices and clothing irons.

Hence it is desirable to provide improved PE/PC blend compositions, including flame retardant blend compositions, where desirable properties of strength, stiffness and high impact strength as well as good color stability after processing at polyester processing temperatures or after being repeatedly subject to use temperatures in excess of 120° C. over a period of time are achieved.

### SUMMARY OF INVENTION

PE/PC blend compositions having good color stability are prepared by incorporating a phosphate quencher into the composition in the form of a concentrate consisting essentially of a polyester resin having the phosphate quencher uniformly dispersed therein. The concentrate consists essentially of a uniform mixture of a polyester resin and from about 5 to about 75 percent by weight, based on the weight of said resin, of a Periodic Table Group I or Group II metal phosphate.

A polyester composition comprises a mixture of: a) at least one polyester resin; b) at least about 0.25% by weight, based on the weight of said polyester resin, of a concentrate consisting essentially of uniform mixture of a polyester resin and from about 5 to 75% by weight of a Periodic Table Group I or Group II metal phosphate; c) at least one polycarbonate polymer present in the composition at a weight ratio of polyester resin to polycarbonate polymer in the range of from about 10:90 to 90:10;

and d) a light-colored metal oxide or metal sulfide pigment different e) and, optionally, a halogenated organic flame retardant and an inorganic flame retardant synergist for imparting flame retardant properties.

Additionally, a method for preparing a polyester composition having enhanced color stability comprises forming a mixture comprising: a) at least one polyester resin; b) at least about 0.25% by weight based on the weight of said polyester resin of a concentrate consisting essentially of uniform mixture of a polyester resin and from about 5 to 75% by weight, based on the weight of said concentrate, of a Periodic Table Group I or Group II metal phosphate; c) at least one polycarbonate polymer present in the composition at a weight ratio of polyester resin to polycarbonate polymer in the range of from about 10:90 to 90:10; and d) a light-colored metal oxide or metal sulfide pigment different and, e) optionally, a halogenated organic flame retardant and an inorganic flame retardant synergist.

The compositions desirably have enhanced color stability and even improved impact properties where the metal phosphate quencher is incorporated in the composition in the form of a concentrate as compared with analogous compositions where the metal phosphate is incorporated in the neat form.

### DETAILED DESCRIPTION

Polyester components used include crystalline or semi-crystalline resins derived from aliphatic or cycloaliphatic diols, or mixtures thereof, containing 2 to about 10 carbon atoms and at least one aromatic dicarboxylic acid wherein the aromatic group is a C₆ to C₂₀ aryl radical. Examples of aromatic dicarboxylic acids are isophthalic or terephthalic acid, 1,2-di(p-carboxyphenyl)ethane, 4,4′-dicarboxydiphenyl ether, 4,4′ bisbenzoic acid and mixtures thereof.

All of these acids contain at least one aromatic nucleus. Acids containing fused rings can also be used, such as 1,4-1,5- or 2,6-naphthalene dicarboxylic acids. The preferred dicarboxylic acids are terephthalic acid, isophthalic acid, naphthalene dicarboxylic acid or mixtures thereof.

The most preferred polyesters are poly(ethylene terephthalate) (PET), poly (butylene terephthalate (PBI), poly(ethylene naphthanoate) (PEN), poly(butylene naphthanoate) (PBN), poly(propylene terephthalate) (PPT), poly (cyclohexanedimethylene terephthalate) (PCT) or mixture of these resins.

Also contemplated herein are the above polyesters with minor amounts e.g., from about 0.5 to about 15 percent by weight, of units derived from aliphatic acids and/or aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

The preferred poly(1,4-butylene terephthalate) resin used in this invention is one obtained by polymerizing a glycol component, at least 70 mol %, preferably at least 80 mol % of which consists of tetramethylene glycol, and an acid component at least 70 mole %, preferably at least 80 mole % of which consists of terephthalic acid, and polyester-forming derivatives thereof.

The polyesters preferred for use herein have an intrinsic viscosity of from about 0.4 to about 2.0 dl/gm, measured in a 60-40 phenol/tetrachloroethane mixture or similar solvent at 23-30° C. These materials also have a melt viscosity in excess of about 1100 poise at 250° C. as measured by ASTM method D-1238.

Blends of polyesters may also be employed in the composition. Preferred polyester blends contain poly(ethylene terephthalate) and poly(1,4-butylene terephthalate). When blends of these preferred components are employed, the polyester resin component can comprise from about 5 to about 50 parts by weight poly(ethylene terephthalate) and from about 95 to about 50 parts by weight poly(1,4-butylene terephthalate), based on 100 parts by weight of both components combined.

Also, blends of relatively low molecular weight polybutylene terephthalate resin may be used with a relative high molecular weight polybutylene terephthalate as set forth in U.S. Pat. No. 5,589,530 to Walsh. The low molecular weight polybutylene terephthalate is a PBT resin having a melt viscosity of less than 600 poise at 250° C.

Polyester resins as described above are also used as the polymer matrix portion used to form the quencher concentrate. The resin present in the quencher concentrate may be the same or may be a different polyester than that used as the main resin component of the polyester composition.

Preferred quenchers which are present in the polyester concentrate of this invention are Periodic Table Group I or Group II metal acid phosphates, preferably in the form of the low hydrates. Preferred metals are Group II metals such as alkaline earth metals and zinc. More preferred quenchers are calcium phosphate and zinc phosphate, most preferably monocalcium or monozinc phosphate monohydrate and mixtures thereof.

The quencher may be mixed with the polyester resin to form a concentrate containing about 5 to 75%, more preferably about 5 to 50% and most preferably about 10 to 30% by weight of the quencher based on the weight of the resin.

The concentrate “consists essentially of” a uniform mixture of the resin and quencher by which is meant that the concentrate does not contain any ingredients which are reactive with or can be made to be reactive with the quencher to form a discolored reaction product, such as antimony oxide and/or certain light colored pigments such as zinc sulfide. The concentrate may however contain minor amounts of additional ingredients such as polymers other than polyesters, stabilizers, antioxidants and the like which do not react with and discolor the quencher concentrate.

The concentrate may be prepared by forming a uniform mixture of the polyester resin, the quencher in powder form and other optional ingredients (if any) and passing a melt of the mixture through a mixer/extruder to form pellets of the concentrate. Conventional single or double screw extruders may be used to form the concentrate mixture, with a preferred temperature profile ranging from about 250° to 280° C. from feed zone to die head.

The quencher concentrate is incorporated in the polyester resin composition at a level sufficient to essentially deactivate catalyst residues present in the polymer components of the composition. Generally, from about 0.25 to 25% by weight, more preferably from about 0.5 to 15% by weight of the concentrate, based on the total weight of polyester resin present in the composition, is sufficient to accomplish this purpose.

The polycarbonates useful in the resin blends of the present invention are well known to those skilled in the art and can comprise non-aromatic as well as aromatic forms and also include copolyester carbonates.

With respect to aromatic polycarbonates, these can be made by those skilled in this art or they can be obtained from a variety of commercial sources. They may be prepared by reacting a dihydric phenol with a carbonate precursor, such as phosgene, a haloformate or carbonate ester. Typically they will have recurring structural units of the formula:

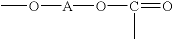

wherein A is a divalent aromatic radical of the dihydric phenol employed in the polymer producing reaction. Preferably, the aromatic carbonate polymers have an intrinsic viscosity ranging from 0.30 to 1.0 dl/g (measured in methylene chloride at 25° C.). By dihydric phenols is meant mononuclear or polynuclear aromatic compounds containing two hydroxy radicals, each of which is attached to a carbon atom of an aromatic nucleus. Typically, dihydric phenols include 2,2-bis(4-hydroxyphenyl)propane; 2,2-bis(3,5-dimethyl-4-hydroxyphenyl)propane; 4,4′-di-hydroxydiphenyl ether; bis(2-hydroxyphenyl)methane and mixtures thereof.

Suitable polycarbonate polymers and their method of preparation are more specifically disclosed in U.S. Pat. No. 5,354,791, the complete disclosure of which is incorporated herein by reference.

In a particularly preferred embodiment of the invention wherein halogenated compounds are included in the composition to provide compositions having enhanced flame retardant properties, all or a portion of the polycarbonate component of the composition may comprise chlorinated or brominated versions of the polycarbonates described above. Preferred halogenated polycarbonates include brominated oligomers prepared by reacting a brominated bisphenol-A with a carbonate-forming reagent to form a brominated polycarbonate, e.g., tetrabromobisphenol-A polycarbonate. These brominated oligomers may contain from about 5 to 30 wt % of bromine.

The polycarbonate polymer or mixture of two or more different polycarbonate polymers may be present in the composition at a level such that the weight ratio of polyester resin to polycarbonate polymer is in the range of from about 10:90 to about 90:10, more preferably from about 25:75 to 75:25. In the most preferred embodiment of the invention, the polycarbonate polymer comprises from about 10 to about 45% by weight of the total polymer content of the composition.

Other flame retardants which can be used to make flame retardant compositions in addition to or as a substitute for the halogenated polycarbonates described above include chlorinated or brominated materials, preferably brominated materials such as polybromophenyl ethers, brominated BPA polyepoxide, brominated imides, poly (haloaryl acrylate), poly (haloaryl methacrylate), or mixtures thereof. Poly(haloaryl acrylate) is preferred with the most preferable being poly (pentabromobenzyl acrylate, PBB-PA). PBB-PA has been known for some time and is a valuable flame-retardant material useful in a number of synthetic resins. PBB-PA is prepared by the polymerization of pentabromobenzyl acrylate ester (PBB-MA).

Examples of other suitable flame retardants are brominated polystyrenes such as polydibromostyrene and polytribromostyrene, decabromobiphenyl ethane, tetrabromobiphenyl, brominated alpha, omega-alkylene-bis-phthalimides, e.g. N,N′-ethylene-bis-trabromophthalimide, and oligomeric brominated carbonates end-capped with phenoxy radicals. Tetrabromobisphenol can also be reacted through its glycidyl ether derivative to form epoxy or phenoxy resins which are useful as flame retardant additives. Other aromatic carbonate flame retardants are set forth in U.S. Pat. No. 4,636,544 to Hepp, the complete disclosure of which is incorporated hereby by reference.

The halogenated flame retardant is added to the composition at a level sufficient to enhance the flame retardant properties of the composition. Generally speaking, from about 1 to about 30% by weight, more preferably from about 2 to 25% by weight, based on the weight of the total composition, is sufficient to provide compositions having good burning ratings under the standard UL-94 test protocols, i.e., V-0, V-1 or V-2 ratings. Where the polycarbonate component of the composition itself comprises a halogenated material, then no additional non-polycarbonate flame retardant may be required to achieve such ratings.

The flame retardants are typically used with a synergist, particularly inorganic antimony compounds, which tend to enhance the flame retardant properties of the halogenated materials present in the compositions. Such compounds are widely available or can be made in known ways. Typically, inorganic synergist compounds include Sb₂O₅, SbS₃ and the like. Especially preferred are antimony oxides such as antimony trioxide (Sb₂O₃). Synergists such as antimony oxides are typically used at a level of about 0.5 to 15 percent, and more preferably from 1 to 6 percent by weight based on the weight percent of resin in the final composition.

Inorganic pigments are also commonly included in polyester compositions of the type described herein to produce colored finished articles. Where light colored articles are desired, most or all of the pigment content will include white or beige colored inorganic metal oxides or sulfides in powder form such as titanium dioxide, zinc oxide, zinc sulfide and lithopone which is a mixture of zinc sulfide and barium sulfate. These light colored pigments are commonly included in such compositions at a level of from about 0.1 to 20% by weight, more preferably from about 0.5 to 10% by weight, based on the weight of the total composition.

As pointed out above, it is the problem of discoloration of light-colored articles caused by chemical reaction of the phosphate quencher with many light-colored pigments present in the compositions and/or its reaction with the antimony compound synergist present in flame retardant compositions which is addressed by the present invention.

The compositions may also contain one or a mixture of reinforcing filler. Suitable fillers include silica; silicates such as talc or mica; carbon black; and reinforcing fibers, such as carbon fiber, aramide fiber or glass fiber. Glass fibers may be composed of S-glass or metal silicate glass (E-glass) and may comprise short, chopped glass fibers with a circular cross section ranging in diameter from about 2×10⁻⁴ to 8×10⁻⁴ inch and about 0.2 to 2 cm in length. Such glass fibers are normally supplied by the manufacturers with a surface treatment compatible with the polymer component of the composition, such as a siloxane or polyurethane sizing. When used in the composition, the reinforcing filler is normally included at a level of from about 1 to 50 parts by weight, more preferably from about 5 to 40 parts by weight, per 100 parts by weight of the total polymer composition.

The composition may also include one or more anti-dripping agents which have the properties of preventing or retarding resin from dripping while the resin is subjected to burning conditions. Specific examples of such agents include silicone oils, silica (which also serves as a reinforcing filler), asbestos and fluorine-containing polymers. Examples of fluorine-containing polymers include fluorinated polyolefins such as polytetrafluoroethylene, tetrafluoroethylenel hexafluoropropylene copolymers, tetrafluoroethylene/ ethylene copolymers, polyvinylidene fluoride and polychlorotrifluoroethylene. Preferred such fluorine-containing polymers have a melt viscosity at 350° C. of about 1.0×10⁴ to 1.0×10¹¹ poises. When used, the anti-dripping agent is added to the composition at a level of about 0.05 to 5 parts by weight, more preferably from about 0.1 to 4 parts by weight, based on the weight of the total polymer composition.

The compositions may also optionally contain up to about 20 wt % of one or more other polymeric materials which serve to further improve impact properties or which facilitate thermoprocessing of the composition. Suitable materials include olefin copolymers such as copolymers of ethylene with alkyl acrylates or vinyl acetate; elastomeric copolymers of butadiene with styrene, acrylonitrile or an acrylate; ABS copolymers; copolymers of styrene with acrylonitrile or an acrylate; and like materials. These materials may also be used to form pre-mixed concentrates in combination with other ingredients present in the composition to facilitate dispersion of those ingredients during processing.

The composition may also contain a number of other conventional additives such as plasticizers, processing aids, stabilizers, antioxidants, nucleants, dyes, mold release agents and the like. These are added as desired for their conventionally employed purposes.

The polymer compositions are produced by mixing the additives in liquid or finely divided form through the polymer. The method of producing the composition is not critical so long as the method results in a relatively uniform mixture. In a preferred embodiment the compositions are produced by heating the polymer until molten and by mixing the other ingredients with the polymer by use of a high-shear mixers or extruders. The concentrate containing the polyester mixed with the phosphate quencher may be added to the mix as preformed pellets or as a molten mix. Preferred melt processing temperatures range from about 260°-300° C., more preferably 265 °-280° C. The composition may be extruded through a die head as strands which are subsequently pelletized for further use.

The compositions may be processed by injection molding or other conventional thermoforming processes to produce shaped articles useful in a variety of applications such as described above, particularly applications where exposure to high temperatures are likely to be encountered.

The components of the formulations presented in Table 1 were tumble blended and then extruded on a 2.5″ 30:1 L/D HPM single-screw extruder equipped with a vacuum vented, double-wave screw. A processing profile of 255-265° C. from feed-zone to die-head was employed. Monocalcium phosphate monohydrate (MCP) concentrate was prepared by similarly extruding a dry-blended mixture of 20 parts by weight MCP and 80 parts by weight poly(butylene terephthalate). Amounts shown in Table 1 are parts by weight.

TABLE I
Sample formulations of flame-retardant polyester compositions with
MCP (R1 and R2) and MCP concentrate (E1 and E2)

| FORMULATION | R1 | R2 | E1 | E2 |
|---|---|---|---|---|
| PBT¹ | 58.2 | 57.2 | 57.0 | 56.0 |
| MCP² | 0.3 | 0.3 | — | — |
| MCP concentrate | — | — | 1.5 | 1.5 |
| Antimony trioxide/ethylene vinyl | 3.5 | 3.5 | 3.5 | 3.5 |
| acetate (85/15 by weight) | | | | |
| Teflon/Styrene-co- acrylonitrile (50/50 | 0.6 | 0.6 | 0.6 | 0.6 |
| by weight)³ | | | | |
| Rexene PE1903 EVA⁴ | 1.0 | 1.0 | 1.0 | 1.0 |
| Penetaerythritol tetrasterate | 0.20 | 0.20 | 0.20 | 0.20 |
| Irganox 1076⁵ | 0.20 | 0.20 | 0.20 | 0.20 |
| Glass Fiber | 17.0 | 17.0 | 17.0 | 17.0 |
| Brominated polycarbonate | 19.0 | 19.0 | 19.0 | 19.0 |
| (26% by weight Bromine) | | | | |
| Zinc Sulfide⁶ | 0 | 1.0 | 0 | 1.0 |

¹Poly (butylene terephthalate) having a melt viscosity of 6500 poises at 250° C.
²Monocalcium phosphate monohydrate
³Anti-drip agent concentrate
⁴Copolymer of ethylene and vinylacetate
⁵Antioxidant from Ciba-Geigy Corporation
⁶Pigment available from Sachtolith under the designation HD-S.

The compositions of Table 1 were molded to form Izod bars of 0.125″ thickness under standard (no dwell in barrel) and abusive (4 minute dwell in barrel) conditions on an 85 ton Van Dorn molding machine with a set temperature of 260° C. Color measurements were performed on the bars using a MacBeth CE7000 spectrophotometer and the following test characteristics: Equation-CIEL *a*b*; Illuminat-D65; Observer-10° (specular gloss included). The bars were also tested for Unnotched Izod Impact (UNI) at room temperature using the ASTM D256 test procedure. Melt Viscosity (MV) of formulations was measured at 250° C. with a Tinius Olsen model UE-4-78 viscometer, a weight of 5000 g, and an orifice diameter of 0.0825″. In addition, melt viscosity at 250° C. with 5 and 10 minute dwell times in the melt was measured using a Kayeness rheometer. Test results are shown in Table II.

TABLE II

| Comparison of Properties of | | | | |
|---|---|---|---|---|
| sample formulations with MCP | | | | |
| and MCP concentrate. | | | | |
| PROPERTIES: | | | | |
| Color match | R1 | R2 | E1 | E2 |
| Standard Molding: ΔL | 0* | −6.75 | 1.16 | 1.41 |
| Δa | 0* | 3.95 | −0.229 | −0.269 |
| Δb | 0* | 1.93 | −0.372 | −0.531 |
| ΔE/color change vs. Ref | 0*/— | 8.05/ | 1.24/ | 1.53/ |
| | | brown | whiter | whiter |
| Abusive Molding: ΔL | −0.238 | −9.52 | −0.144 | 1.11 |
| Δa | 0.060 | 5.06 | −0.256 | −0.264 |
| Δb | 0.364 | 2.93 | 0.712 | −0.064 |
| ΔE/color change vs. ref. | 0.439/ | 11.2/ | 0.770/ | 1.14/ |
| | none | brown | none | whiter |

TABLE III

| PROPERTIES: Rheological & | | | | |
|---|---|---|---|---|
| Mechanical | R1 | R2 | E1 | E2 |
| MV @ 250° C. (P) | 7315 | 7176 | 7697 | 6757 |
| Kayeness MV @ 250° C.: | 3149 | 3488 | 3330 | 3372 |
| 5 min. (P) | | | | |
| Kayeness MV @ 250° C.: | 2999 | 3410 | 3224 | 3247 |
| 10 min. (P) | | | | |
| UNI: standard molding (ft-lb/in) | 9.36 | 9.71 | 10.6 | 10.1 |
| UNI: abusive molding (ft-lb/in) | 7.55 | 7.72 | 10.3 | 8.19 |

Tables II and III clearly illustrate color and properly retention with MCP concentrate (E1 and E2) under both standard and abusive molding conditions. In fact, E1 and E2 exhibit superior impact properties vs. R1 and R2. Moreover, E1 and E2 display excellent melt stability (i.e. no MV build) as a function of dwell time in the melt, as depicted by the Kayeness measurements, thus indicating efficient quenching by the concentrate.

1. A polyester composition comprising a mixture of:
a) at least one first polyester resin;
b) at least about 0.25% by weight based on the weight of the first polyester resin of a concentrate consisting essentially of a uniform mixture of a second polyester resin, wherein the second polyester resin may be the same or different as the first polyester resin, and from about 5 to 75% by weight based on the weight of the concentrate of a Periodic Table Group I or Group II metal phosphate;
c) at least one polycarbonate polymer present in the composition at a weight ratio of the first and second polyester resins to polycarbonate polymer in the range of from about 10:90 to 90:10;
d) at least one light-colored pigment additive selected from the group consisting of a metal oxide or metal sulfide; and
e) optionally, an organic halogenated flame retardant and an inorganic flame retardant synergist.

2. The composition of claim 1 wherein the pigment additive is selected from the group consisting of titanium dioxide, zinc oxide, zinc sulfide and lithopone.

3. The composition of claim 2 wherein the pigment additive comprises zinc sulfide.

4. The composition of claim 1 wherein the halogenated flame retardant comprises a halogenated polycarbonate present in an amount sufficient to impart flame retardant properties to the composition, and an antimony compound as a synergist.

5. The composition of claim 4 wherein the pigment additive is selected from the group consisting of titanium dioxide, zinc oxide, zinc sulfide and lithopone.

6. The composition of claim 5 wherein the pigment additive comprises zinc sulfide.

7. The composition of claim 4 wherein the antimony compound comprises antimony trioxide.

8. The composition of claim 1 further comprising about 1 to about 50 parts by weight per 100 parts by weight of the composition of a reinforcing filler.

9. The composition of claim 8 wherein the reinforcing filler comprises glass fibers.

10. The composition of claim 1 further comprising about 1 to about 30% by weight, based on the weight of the total composition, of at least one organic flame retarding agent different from said polycarbonate polymer, and an antimony compound as a synergist.

11. The composition of claim 10 wherein the pigment additive is a selected from the group consisting of titanium dioxide, zinc oxide, zinc sulfide and lithopone.

12. The composition of claim 11 wherein the pigment additive comprises zinc sulfide.

13. The composition of claim 10 wherein the antimony compound comprises antimony trioxide.

14. The composition of claim 1 wherein the metal phosphate comprises a Group II metal phosphate.

15. The composition of claim 14 wherein the metal phosphate is selected from the group consisting of calcium phosphate, zinc phosphate and mixtures thereof.

16. The composition of claim 15 wherein the concentrate is present in the composition at about 0.5 to about 15% by weight, based on the total weight of polyester resin in the composition.

17. The composition of claim 1 wherein the first polyester resin and the second polyester resin are selected from the group consisting of polyethylene terephthalate, polybutylene terephthalate, polyethylene naphthanoate, polybutylene naphthanoate, polypropylene terephthalate, polycyclohexanedimethylene terephthalate and mixtures thereof.

18. The composition of claim 17 wherein the first polyester resin and the second polyester resin comprise polybutylene terephthalate.

19. The composition of claim 1 wherein the composition further comprises an anti-dripping agent.

20. The composition of claim 1 wherein the composition further comprises one or more of plasticizers, processing aids, stabilizers, antioxidants, nucleants, dyes, and mold release agents.

21. A flame retardant polyester composition comprising a mixture of:
a) a polybutylene terephthalate resin;
b) about 0.25 to about 25% by weight, based on the total weight of polybutylene terephthalate resin present in the composition, of a concentrate consisting essentially of a uniform mixture of a polyester resin and a Periodic Table Group II metal phosphate;
c) a brominated polycarbonate oligomer containing about 5 to about 30 wt % bromine, said brominated polycarbonate present at a level of about 10 to about 45% by weight based on the total polymer content of the composition;
d) about 0.5 to about 15 wt %, based on the polymer content of the composition, of an antimony oxide synergist;
e) about 0.1 to about 20 wt %, based on the weight of the total composition, of a zinc sulfide pigment; and
f) about 0 to about 50 parts by weight per 100 parts by weight of the composition, of reinforcing glass fibers.

22. The composition of claim 21 wherein the Group II metal phosphate is selected from the group consisting of calcium phosphate, zinc phosphate and mixtures thereof.

23. The composition of claim 22 containing at least 1 part by weight of the reinforcing glass fibers.
